(19) United States
(12) Patent Application Publication
(10) Pub. No.: US 2016/0055467 A1
(43) Pub. Date: Feb. 25, 2016

(54) COMMODITY DISCOUNT CARD

(71) Applicant: Michael A. Racusin, Northbrook, IL (US)

(72) Inventor: Michael A. Racusin, Northbrook, IL (US)

(21) Appl. No.: 14/466,409

(22) Filed: Aug. 22, 2014

(51) Int. Cl. G06Q 20/14; G06Q 20/20; G06Q 30/02

(52) U.S. Cl. CPC G06Q 20/145; G06Q 30/0207; G06Q 20/20

(57) ABSTRACT

A discount commodity system is disclosed. The discount commodity system allows a consumer to purchase a fixed number of units of a commodity at an agreed upon price without taking delivery at the time of the purchase. In one embodiment, a purchaser is issued a discount card, similar to a credit card, that allows the consumer to purchase a desired number of units of a commodity at a point of sale (POS) terminal at the agreed upon discount In this embodiment, the discounted retail price of the commodity is based upon the raw commodity price not including any local fees, as discussed above, that are normally added on. As such, the discount commodity system disclosed herein can be provided without any geographical constraints.

### BACKGROUND OF THE INVENTION

1. Field of the Invention

The present invention relates to a commodities discount card and a method for selling commodities, such as fuel, that allows a purchaser to purchase a commodity at a discount without any geographical constraints because the invention automatically adjusts the price pursuant to location.

2. Description of the Prior Art

Various systems and methods are known for purchasing commodities at a discount. In general, these systems allow consumers to pre-purchase a predetermined amount of a commodity, such as fuel, at a discounted price. Examples of such systems are disclosed in Canadian published patent application no. CA 2,684,118 A; Korean published patent application no. KR 2002-00074964 A; U.S. Pat. Nos. 7,742,942; 8,504,465 and US Published Patent Application Nos.: US 2006/086787 A1 and US 2007/0276738. A system for purchasing discounted commodities is also disclosed in the literature: “Portland Fixed Price Fuel Card”; www.poprtland-fuelcard.co-uk/.

Canadian published patent application no. CA 2,684,118 A discloses a system for providing discounted fuel cards that allow consumers to purchase fuel at a discounted price. In this system, a third party negotiates a discount with a fuel supplier. The third party allocates a portion of the discount to the retail fuel vendor with the balance of the discount is allocated to the consumer.

For example, assume a normal pump price per gallon of $3.00 per gallon and the third party negotiates a discount of $0.50 per gallon. Further assume that the third party allocates $0.10 per gallon as profit and $0.05 per gallon for the retail fuel vendor. In this example, the consumer would pay a discounted price of $2.65 per gallon with an extra $0.05 per gallon going to the retail fuel vendor and $0.10 per gallon going to the third party.

Korean published patent application no. KR 2002-00074964 A discloses another discount system discloses a system in which consumers can obtain a membership card and purchase commodities from predetermined manufacturers from predetermined stores upon presentation of the discount membership card.

U.S. Pat. No. 7,742,942 discloses yet another type of discount system. A discounted price per unit for fuel is associated with a certain credit card. When a consumer purchases fuel with the certain credit card, the system automatically identifies the certain credit card and applies the discounted price per unit for the fuel being purchased.

US Patent Application Publication No. 2006/0086787 A1 discloses a discount system associated with the sale of aviation fuel. In this system, consumers, i.e. pilots, that qualify for a discount are registered in a database. In this system, fuel is purchased at an airport and paid for by the pilot with a credit card at a point of sale (POS) terminal. The POS terminal is connected to a network that includes a database. Once the pilot swipes their credit card at the POS, the system automatically checks whether the purchaser is registered in the database for a discount. If so, the credit card is debited at the discounted price. If the purchaser is not registered for a discount, the credit card is debited for the full purchase price.

US Patent Application Publication No. 2007/0276738 A1 a system that allows consumers to prepay for a specified amount of fuel at a discounted price. The consumer is issued a magnetic card that allows the consumer to purchase the specified amount of fuel at the discounted price at various merchants at a later time. In this system, the purchaser is issued a magnetic card that is similar to a conventional credit card. The magnetic card enables the purchaser to purchase fuel at a discounted price. The non-patent literature, “Portland Fixed Price Fuel Card”, as discussed above, similarly offers a prepaid magnetic card for purchasing fuel at a discounted price.

Other known discount commodity systems are similar to a type of security known as an option. For example, U.S. Pat. No. 8,504,465, assigned to Goldman Sachs, discloses an option based discount system for the purchase of fuel. In this system, the consumer purchases an option to purchase fuel at a predetermined strike price, i.e. discount price. The strike price is normally less than a premium price, i.e., retail price. As long as the consumer satisfies a predetermined usage restriction, the consumer can redeem the difference between the retail price paid for fuel purchased and the strike price for purchases in which the actual purchase price exceeds the strike price.

Other systems are known which provide price protection associated with the purchase of a commodity, such as fuel. Examples of these systems are disclosed in U.S. Pat. No. 8,019,694; 8,065,218; 8,086,517; 8,156,022; and 8,160,952. These patents all relate price protection contracts which

The '218 patent relates to an insurance policy. In this system, the consumer pays an insurance premium in connection with a strike price for a commodity. In this system, the consumer is reimbursed for any amount paid for the insured commodity that exceeds the strike price.

The '694; '517 ; '022 and the '952 patents all disclose price protection contracts. In general, these price protection contracts are similar to the insurance protection and protect a consumer from price fluctuations of a retail commodity, such as fuel. Several of the disclosed price protection contracts impose constraints on the consumer. For example, the '517 patent discloses price protection contract which requires the consumer to purchase a specified quantity of fuel from a specified locale during a specified time period. The '694 and '022 patents also disclose price protection contracts which require a consumer to purchase the commodity, i.e. fuel, at a specified locale.

Due to price variances of retail commodities at different locales, some of the commodity discount systems restrict discounts to specific locales. One reason for the differences of commodity prices is that add-on charges to the price of the commodity vary by locale. For example, for gasoline, various state and local taxes are added to the price of each gallon of gasoline. For example, in the city of Chicago, recent state and local taxes per gallon of gasoline are as follows:
Cook County and Chicago sales tax—11.02 ¢
Illinois State Sales Tax—19.68 ¢
Illinois Environmental Tax—1.1 ¢
Cook County and Chicago Motor Fuel Tax—11.0 ¢
Illinois Motor Fuel Tax—19.0 ¢
Federal Motor Fuel Tax 18.4 ¢

All of the various taxes mentioned above except for the Federal Motor Fuel Tax will vary from locale to locale. Different locales will likely have different taxes and may add include other charges based upon the locale, such as delivery charges. For example, the recent taxes per gallon of gasoline sold in New York City are as follows:
Federal Motor Fuel Tax—18.4 ¢
State Petroleum Business Tax—17.8 ¢
State Motor Fuel Excise Tax—8 ¢
State Petroleum Testing Fee—0.05 ¢
State Spill Tax—0.3 ¢
State Sales Tax—8 ¢
City Sales Tax in MTA region—16.9 ¢

In addition to the various taxes and geographical based fees, as discussed above, a delivery charge may be added to the price of each gallon of gasoline. Such delivery charges in New York City amount to 2 ¢ per gallon of gasoline. As used herein, all taxes and geographical based fees including delivery fees are hereinafter referred to as local fees.

Due to the variance in the local fees, many discount systems are limited to specific geographical areas. For example, U.S. Pat. No. 6,980,960 assigned to Goldman Sachs discloses an incentive system for fuel purchases. The incentive system is limited to specific geographical areas. U.S. Pat. No. 8,019,694, assigned to Pricelock, Inc. discloses a price protection contract, as discussed above, that is also limited to specific geographical areas. US Patent Application Publication No. 2013/0198074 A relates to a method that allows a consumer to prepay a predetermined number of units of gasoline at one or more predetermined retail gasoline locations in predetermined geographic areas . . . .

The various commodity discount systems discussed above impose various constraints on the consumer. Of the various constraints imposed on consumers by the various commodity discount systems, the most limiting constraint is the geographical constraint. Such geographical constraints significantly impede the benefits of such commodity discount systems. For example, a commodity discount system with a geographical constraint would be of limited use to various potential purchasers, such as fleet automobile owners whose employees operate in multiple geographical areas.

Thus, there is a need for a discount system for commodities, such as gasoline that does not impose geographical constraints.

### SUMMARY OF THE INVENTION

Briefly, a multiple embodiments of a discount commodity system is disclosed. The discount commodity system allows a consumer to purchase units of a commodity at a discounted price without taking delivery at the time of the purchase. The discount is applied to the unit price before local charges which can vary in different locales. In one embodiment of the discount commodity system, the purchaser is issued a discount card, similar to a credit card that allows the purchaser to purchase units of a commodity at a point of sale (POS) terminal at a discounted price. Alternatively, the purchaser may be issued a commodity discount pass with a bar code, similar to an airport boarding pass, that can be used to purchase the commodity In accordance with an important aspect of the system, the discount commodity system disclosed herein allows a purchaser to purchase a commodity without any geographical constraints.

### DESCRIPTION OF THE DRAWING

These and other advantages of the present invention will be readily understood with reference to the following specification and attached drawing wherein:

FIG. 1 is a block diagram of an exemplary system for implementing the discount commodity system disclosed herein.

FIG. 2 is an exemplary flow chart for the exemplary system illustrated in FIG. 1.

### DETAILED DESCRIPTION

The invention relates to a method for selling commodities at a discount and a discount commodity system is disclosed that allows a consumer to purchase units of a commodity at a discounted unit price without taking delivery at the time of the purchase. As described herein, a unit price refers to the price of a commodity before local charges are added on. In all embodiments of the system, a discount is applied to the unit price before local charges are added on defining a discounted unit price. Local charges refer to per unit taxes and other charges that are based upon the locale. As such, the discount commodity system disclosed herein does not impose any geographical constraints on the purchaser since the discounted unit price will not vary in different locales.

The term commodity includes various items that are sold on a per unit basis and upon which local charges are also added on a per unit basis. Examples of such commodities include but are not limited to energy related commodities, such as, gasoline, diesel fuel, airline fuel, natural gas and propane gas. The term “commodity” also includes other commodities that are not energy related, such as wheat corn and soy beans and other commodities. It is also understood that such commodities can include commodities that can be purchased by way of POS terminals as well as commodities that can be purchased by other known payment methods.

There are multiple embodiments of the discount commodity system. In one embodiment of the discount commodity system, the purchaser is issued a discount commodity card, similar to a credit card that allows the consumer to purchase units of a commodity at a point of sale (POS) terminal at the agreed upon discount. In other embodiments of the discount commodity system,the purchaser can purchase a desired number of units of the commodity on-line by multiple payment methods, for example, by way of a credit card, or by way of a smart phone or a PayPal account. In lieu of a credit card, the purchaser may be issued a discount purchase pass with a bar code which can be printed out on line or sent to a smart phone in a similar manner as an airline boarding pass. With such a discount commodity pass, in order for the purchaser to pay a quantity of the commodity, the bar code is scanned at a POS.

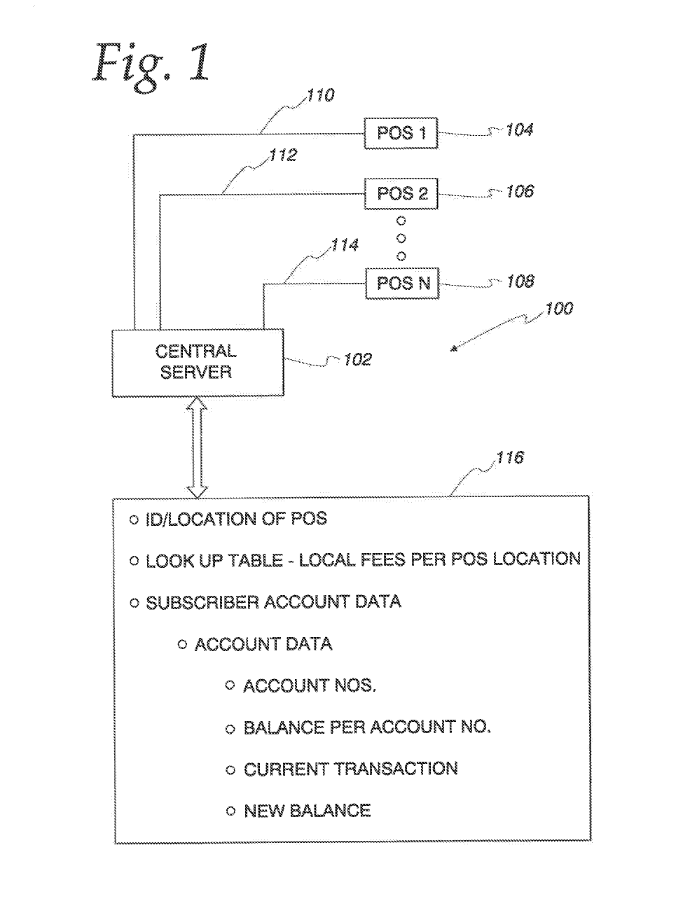

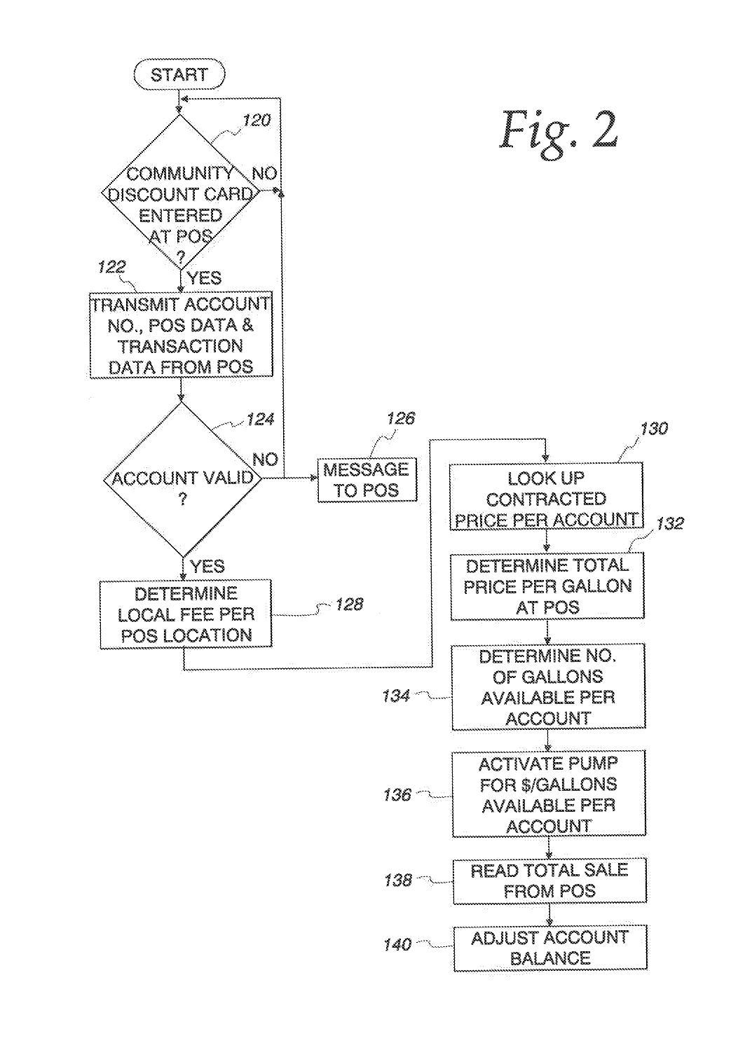

There are multiple embodiments of the system. In a first embodiment, the system is based upon a fixed cash amount and a fixed quantity of units of the commodity. In this embodiment, the purchaser an purchases an specified number units of a commodity for a total purchase price and a limited number of units of the commodity. For example, in this embodiment, the purchaser can purchase a commodity discount $1000 worth with a limit of 250 discounted units of a commodity The purchaser's account would be exhausted solely when the cash credit, i.e. $1000, is exhausted or the purchaser has purchased 250 units, whichever occurs first. The first embodiment is described below in connection with FIGS. 1 and 2.

In a second alternate embodiment, the purchaser can purchase a discount commodity card or discount commodity pass for purchase of an unspecified number of units of the commodity for a discounted unit price+local charges for a fixed amount of money. For example, assume a purchaser purchases a discount commodity card or discount commodity pass for $1000. The best way to understand the system is by example. For example, in one embodiment of the system, assume a purchaser purchases $1000 credit for gas at $3.00 per gallon. If the purchaser purchases gas where the tax+local fees are $1.00 per gallon, the purchaser would have the ability to purchase 1000/4 or 250 gallons of gas at that location or other locations where the tax+local fees are $1.00 per gallon. Now assume the purchaser purchases 10 gallons of gas at a locale where the local fees are $1.00 per gallon. In this situation, 10 gallons×$3.00 per gallon+10 gallons×$1.00 for Tax+local fees=$40.00. At this point, the purchaser has $960 credit left on the discount card or discount purchase pass. Now assume that the purchaser goes to a locale to purchase gas where the local fees are $0.50 per gallon. Since the gas price less taxes+local fees is fixed, the purchaser would be able to purchase $960/$3.5 or 274 gallons of gas.

in a third alternate embodiment of the commodity discount system, the purchaser purchases the right to purchase a fixed number of units of the commodity. In this system, the discount commodity card or discount commodity pass is tied to a credit account of the purchaser, such as a credit card, debit card or PayPal account in a conventional manner. For example, if a purchaser purchased the right to purchase 300 units of the commodity, these purchases would be automatically charged to the purchaser's credit account.

The third embodiment provides an advantage in that purchasers can “pay as they go” and does not require an upfront payment as in the first and second embodiments. Another advantage of the third embodiment is that it can be associated with a gasoline credit card, for example. Gasoline credit cards are becoming more and more extinct as time goes on. Consumers frequently use universal credit cards, such as, Master Card®; Visa®; Discover®; and American Express® cards that can be also be used for a multitude of retail products and services. In order to build brand loyalty, these universal credit cards provide some sort of reward for frequent purchasers based upon the purchases by a customer. In order to attempt to build brand loyalty in a similar way, gasoline retailers, for example, are known to provide rewards in a similar manner. For example, Speedway gas stations in the Midwest offer customers a Speedy Reward card that provides points based upon purchases that can be redeemed for gasoline and other products. Unfortunately retail gas reward cards, such as the Speedy Reward card, have a significant drawback. In particular, purchasers must insert two cards into the retail gasoline point of purchase device; one for the reward and one for payment. As such, it is cumbersome for those who use such gasoline reward cards that are used to getting reward credit by simply using a universal card for credit, such as a Master Card. By incorporating a commodity discount, as discussed herein, into a retail gasoline card, for example, a single gasoline company, that company can differentiate itself from other gas companies and reverse the trend of gasoline credit cards. In this embodiment, the commodity discount card may be brand specific, for example, Exxon®; Shell®, etc. The card would be used for discounted gas and optionally non-discounted gas. Each brand specific card would be assigned an account number, accessible on line or a point of sale terminal to enable a specified amount of discounted gas to be debited to the purchaser's account. In other embodiments, the brand specific card could also be used as a conventional brand specific credit card to enable gasoline to be purchased at a point of sale terminal in a conventional manner.

Although the principles of the invention are applicable to various types of commodities, as discussed above, the commodity discount system is described and illustrated below with respect to gasoline.

Referring first to FIGS. 1 and 2, the first embodiment of the commodity discount system is illustrated and generally identified with the reference numeral 100. The commodity discount system 100 includes at least one central server 102. The central server 102 may be linked to one or more additional servers (not shown) in a conventional manner in remote geographical areas.

The central server 102 is configured to receive point of sale (POS) data from a plurality of retail POS terminals 104, 106 and 108 or alternatively read the data from the discount pass that is either printed or displayed on a smart phone. The retail POS terminals 104, 106 and 108 may be located in different geographical areas, for example, different areas in which there is a variance in the local fees. Each of the retail POS terminals 104, 106 and 108 is connected to the central server 102 by way of a plurality of conventional communication links 110, 112 and 114, respectively. The communication links 110, 112 and 114 may be virtually any conventional wired or wireless communication links that enable bi-directional communication between the central server 102 and the POS terminals 104, 106 and 108.

The box 116 illustrates a simplified version of a database that is accessible by the central server 102. The database 116 may be stored on the central server 102 or may be resident on another server that is accessible by the central server 102.

In this first embodiment of the commodity discount system, purchasers are provided with magnetic cards, for example, similar to conventional credit cards or alternatively, a discount pass. The purchaser is able to purchase credit on a commodity discount card or discount pass in a manner that is similar to the method that credit is purchased on gift cards, for example. After credit has been purchased, for example by cash or credit card, the magnetic strip on the commodity card is validated and the magnetic strip is coded with certain information including the amount of credit associated with the account associated with the card. An account number and vendor associated with the discount may be pre-coded on the magnetic card. Alternatively, such information is coded on a bar code.

As used herein the term “vendor” refers to the issuer of the discount which may be the wholesale commodity distributor or a third party. The term validated refers to the purchase of a discount commodity card with the balance of the credit stored on a database, for example, the database associated with the central server 102.

Once a commodity discount card or discount pass used for a purchase at a retail gasoline station, for example, the magnetic strip on the purchaser's commodity discount card is read by a POS terminal 104, 106 and 108. Alternatively, the bar code may be read by a conventional bar code reader at the POS terminal 104, 106 and 108 The POS terminal 104, 106 and 108 transmits information from the magnetic strip on the commodity discount card or the discount pass to the central server 102 which includes the an account number and may include the current credit balance in dollars and gallons and the discount price per gallon. Alternatively, the current balance and discount price may be stored on a remote server (not shown) accessible by said central server 102.

The POS terminals 104, 106 and 108 additionally transmit representative information to the central server 102 regarding the identification and/or location of the POS terminal 104, 106 and 108 where the purchase was made and the amount of purchase including the number of gallons and optionally the date and time of the purchase.

The POS location information enables the central server 102 to access a lookup table that enables the central server 102 to determine the geographic area associated with the POS terminals 104, 106 and 108 for the purchase. The geographic data allows the central server 102 to look up the local fees associated with the location of the POS terminal 104, 106 and 108. The POS terminals 104, 106 and 108 also transmits information to the central server 102 that is representative of the purchaser's purchase which includes the dollar amount of the purchaser's purchase and the number of gallons purchased and optionally the date and/or time of the purchaser's purchase.

Upon receipt of the identification of the POS terminal 104, 106 and 108, associated with the purchase, the central server 102 looks up the local fees per gallon, for example, by way of a look-up table, and adds the local fees per gallon to the discounted price per gallon (excluding local fees) in order to arrive at a total price per gallon. Based upon the purchaser's account balance or available credit the central server 102 determines the number of gallons that can be dispensed to the purchaser at the current POS terminal 104, 106 and 108.

Before authorizing the dispensing of gasoline i.e. turning the gasoline pump if the purchaser's account has been validated and that there is credit balance available. If either the account is not valid or the card has a zero credit balance, the central server 102 does not send a signal to the POS terminal 104, 106 and 108 to turn the pumps on and may send a message, such as “Account Not Valid” to the POS terminal 104, 106 and 108. If the purchaser's account is valid and includes a credit balance, the central server 102 sends a signal back to the POS terminal 104, 106 and 108 over one of the bidirectional communication links 110, 112 and 114, respectively to turn the pump on for the number of gallons equivalent to the purchaser's current balance at the discounted price per gallon and local fees. The central server 102 monitors the number of gallons being dispensed to the purchaser and will signal the pump to turn off once the gallon or dollar limit of the purchaser's account is at the purchaser's credit limit.

After the gasoline dispensing is terminated by the purchaser, the POS terminal 104, 106 and 108 sends a signal back to the central server 102 that the sale is concluded. Upon receipt of that signal, the central server 102 adjusts the purchaser's account balance. Both the dollar amount and the remaining number of gallons may be adjusted. These revised balances are stored by the central server 102 or alternatively stored at a remote server (not shown) accessible by the central server 102.

A simplified flow chart is illustrated in FIG. 2 It is to be understood that the commodity discount system is not limited to the sequence of steps set forth in FIG. 2. The process may be executed in different sequences in order to reach the vend results, discussed above.

Since the commodity discount card can be used at retail gasoline stations, various credit cards in addition to the commodity discount card will be used to purchase gasoline. As such, the system waits in step 120 for a commodity discount card to be swiped at a POS terminal 104, 106 and 108. Once a the magnetic strip on a commodity discount card is read by a POS terminal 104, 106 or 108, the purchaser account number from the commodity discount card is read by the POS terminal 104, 106 and 108. The purchaser account number along with the transaction data is sent to the central server 102 in step 122. Before sending a signal to turn the pump on to enable dispensing of gasoline, the system determines if the purchaser balance is valid in step 124. If the account is not valid, the system returns to step 120 and waits for another commodity discount card to be swiped at the POS terminal 104, 106 and 108. In this situation a message, such as “Account Not Valid”, may optionally be returned to the POS terminal 104, 106 and 108, as indicated in step 126.

If the purchaser's account is valid, the system will read POS data from the POS terminal 104, 106 and 108 to determine the geographic location of the POS terminal 104, 106 and 108 in order to determine the local fees that are to be applied, as indicated in step 128. In step 130, the central server 102 looks up the contracted price per gallon and the number of gallons available in the purchaser's account in steps 130 and 132. In step 132, the central server 102 determines the total or adjusted price per gallon which is the sum of the contracted price per gallon and the local fees. In step 134, the central server 102 determines the number of gallons that can be purchased based upon the total price per gallon and the amount of money and the number of gallons in the purchaser's account. In step 136, the central server 102 signals the pump at the POS terminal to turn on. Once the pump is turned on, the central server 102 may optionally provide signals to the POS terminal 104, 106 and 108 to display the adjusted price per gallon and the total prices at the adjusted price. The POS terminal will allow the pump to stay on up to the limit of the purchaser's dollar amount or number of gallons limit. Once the pumped gas reaches either limit, the central server 102 sends a signal to the POS terminal to turn it off. Alternatively, as discussed above, the pump may be turned off at the POS terminal 104, 106 and 108 either manually by the purchaser or auto ally when the purchaser's gas tank is full.

Once the pump is turned off, either manually or automatically, the total number of gallons dispensed is transmitted from the POS terminal 104, 106 or 108 to the central server 102 in step 138. The central server 102 determines the total cost of the purchase as follows:

(Discounted price per gallon+local fees)×the number of gallons dispensed=total cost of the purchase.

In step 140, the purchaser's account is adjusted and stored as an account balance by the server 102. Both the number of gallons and the dollar amount are adjusted.

The second and third embodiments of the discount commodity system, mentioned above, are similar to FIGS. 1 and 2. The only difference between all three embodiments is in FIG. 2, block 136. In particular, the second embodiment is based upon a fixed amount of cash. More specifically, in the second embodiment, the purchaser purchases a discount commodity card or discount commodity pass that allows the purchaser to purchase an unspecified number of units of the commodity at a fixed price, for example as illustrated above. In this second embodiment, the pump would only be activated for a fixed dollar amount based upon the current balance in the purchaser's account. In the third embodiment, the pump would only be activated for a fixed number of gallons based upon the available number of gallons in the purchaser's account.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. A method for operating a Point of Sale (POS) terminal in order to enable a predetermined prepaid commodity to be dispensed at a unit discount price excluding all local taxes and fees and debited to a commodity discount card having a predetermined initial prepaid cash value which can be used at a POS, terminal to enable a pump at the POS terminal and debit both the units of the discounted commodity purchased and the local taxes and fees applicable to said purchased units based upon the current cash value of the commodity discount card, the method comprising the steps of:
(a) enabling at least purchaser's account number data from said commodity discount card to be read at said POS terminal;
(b) enabling POS data including at least the location of the POS terminal and the number of units of the commodity pre-purchased and the purchaser's account number to be transmitted to said remote server; said server including a database organized by purchaser account number and the current cash value in the purchaser's account;
(c) automatically determining the maximum number of units of the discounted commodity that can be pumped at said POS terminal in response to said commodity discount card by determining the local taxes and local charges applicable based upon the location of the POS terminal and summing the local taxes and local charges with the per unit discounted commodity price defining a sum and dividing the current cash balance by the sum in order to determine maximum amount of the commodity that can be purchased with the current cash balance;
(d) automatically enabling a pump at said POS terminal for said maximum amount determined in step (c); and
(e) automatically debiting the current transacting of the commodity and the local taxes and fees from the current cash value of purchaser's account in a single transaction.

2. The method as recited in claim 1, wherein said predetermined commodity is an energy related commodity.

3. The method as recited in claim 1, wherein said predetermined commodity is an a non-energy related commodity.

4. The method as recited in claim 2, wherein said predetermined commodity is gasoline.

5. The method as recited in claim 1, wherein step (a) includes the step of reading a magnetic strip at said point of sale (POS) terminals in a similar manner as a conventional credit card.

6. (canceled)

7. A computerized discount commodity card system for the purchase of commodities at a discount unit price by way of Point of Sale (POS) terminals at any locality, said discount commodity card system configured to be used as a prepaid discount card with a prepaid cash value, the discount commodity card system comprising:
a server for receiving data from said POS terminals when a discount commodity card coded with at least the purchaser's account number is used at the POS terminal for purchase of the commodity, said data including at least the purchaser's account number as well as the location of the POS terminal;
a database for storing purchaser account data including the purchaser's account number and, the current cash value in the account associated with the purchaser's commodity discount card and a look up table for storing the local taxes and fees based upon the location of the POS terminal;
wherein said server is configured to determine the maximum number of units of the commodity including the local taxes and fees that can be pumped based upon a current cash value of the purchaser's account taking into account the discounted cost of the commodity and the local taxes and fees for the location of the POS terminal and enabling a pump to be turned on up to said maximum number of units and to debit said cash value of purchaser's account for the number of units of the commodity pre-purchased including the local taxes and fees in a single transaction.

8. (canceled)

9. The computerized discount commodity card system as recited in claim 7, wherein said server is configured to enable costs for items other than said predetermined commodity to be debited to purchaser's account and to take into account the cost of such items when determining the maximum amount of the commodity that can be purchased.

10-11. (canceled)
